(19) United States
(12) Patent Application Publication
(10) Pub. No.: US 2015/0226310 A1
(43) Pub. Date: Aug. 13, 2015

(54) Spoke Design for Sheaves

(71) Applicant: SIEMAG TECBERG GMBH, Haiger (DE)

(72) Inventors: Wolfgang Schubert, Netphen (DE); Hubert Sunderhaus, Duelmen (DE)

(21) Appl. No.: 14/377,630

(22) PCT Filed: Feb. 7, 2013
(86) PCT No.: PCT/EP2013/052427

§ 371 Date: Aug. 8, 2014

(30) Foreign Application Priority Data
Feb. 10, 2012 (DE) 10 2012 002 743.5

(51) Int. Cl. F16H 55/40

(52) U.S. Cl. CPC F16H 55/40

(57) ABSTRACT

The invention relates to a cable pulley for use as a guide device between a conveying means and a cable carrier, comprising a cable pulley ring, a hub (4) and cable pulley spokes (6) connecting the cable pulley ring and hub, wherein the cable pulley spokes (6) are each formed from a single trapezoidal flat material bent multiple times over the cross-section of the cable pulley spoke (6), the wide base of which is arranged on the hub (4).

The present invention relates to sheaves to be used as guide arrangements between a hoisting means and a rope carrier, as described in the independent Claim.

A sheave is essentially a spoke wheel whose circumference is provided with one or more grooves. The grooves serve to guide the ropes. Sheaves are usually made of high-grade steel and are therefore extremely robust and wear-resistant.

As a rule, sheaves have maintenance-free bearings. As the hoisting rope runs along the sheave, an energy loss occurs due to internal rope friction and bearing friction. In principle, a sheave functions like a fixed pulley. Depending on the application, the nominal diameter of a sheave must be 40 to 120 times the nominal diameter of the rope. The nominal diameter of the sheave is the mathematically determined diameter of the sheave related to the bottom of the groove. In the case of systems with hoisting speeds of more than 4 m/s, it is usually necessary to provide the sheaves with a sheave liner. If the hoisting rope is deflected by about 90°, such a sheave is called a deflection sheave.

Especially in mining, sheaves have different functions. Thus, they serve to transfer rope loads to the hoist frame, they increase the wrap angle around the rope carrier, they help to adapt the rope distance to the branch distance, or they simply serve to deflect the rope.

In particular, the sheaves used in mining usually consist of a sheave rim, a hub, and sheave spokes connecting the rim and the hub, which results in sheaves that have the required stability while having an acceptable weight thanks to the wheel/spoke design.

The conventional design of sheaves provides that the sheave spokes consist of conventional rolled members welded to the hub and the sheave.

However, rolled members as spoke material have the disadvantage on the one hand that the material, is not continuously homogenous, which may negatively affect their weldability and thus the quality of the positive material joint to be achieved. Furthermore rolled members as spokes for sheaves also have the disadvantage that the welding spots are difficult to reach due to the geometry of the rolled members and that they are difficult to machine to achieve the necessary surface quality, which increases the manufacturing costs.

To circumvent these problems, it has been tried to replace the rolled members with two U-shaped plates connected with each other on the back, but these are unable to solve the problem that the joints cannot be reached, especially when the weld seam is designed as a full junction.

It is therefore the object of the present invention to provide a sheave without the disadvantages of the state of art, with particular attention to the way in which the spokes are connected to the hub and to the rim of the sheave.

This object is achieved by the characteristics of the independent claim 1, while practical embodiments are described by the characteristics of the sub claims.

The invention calls for a sheave to be used as a guide arrangement between a hoisting means and a rope carrier, with a sheave rim, a hub and sheave spokes connecting the rim and the hub, whereby each sheave spoke consists of a single flat stock member that is multi-curved in cross section of the sheave spoke.

Using flat stock members with a multi-curved cross section solves in a surprisingly simple manner the problems encountered with the state of the art, since using a single component made of flat stock for the individual sheave spokes clearly reduces the complexity of installation and connection, compared with using several rolled members, because it is now only necessary to connect a single component to the hub and to the sheave rim. The use of flat stock members with a multi-curved cross section and of a homogenous material thickness also offers the advantage that the intersection between the spoke and the hub and the sheave rim is clearly easier to reach, which simplifies and therefore reduces the cost of the connection process itself as well as that of the necessary inspection of connection seams or connection points during operation.

In a preferred embodiment, the cross section of the sheave spokes is an S-, Z- or W-shaped undulation, since with these shapes the intersections are considerably easier to reach while a high area moment of inertia is achieved.

Also preferred are sheave spokes formed of a trapezoid flat stock that is shaped in an appropriate undulation and whose broad base is attached to the hub, This preferred embodiment has the advantage that bending forces which could act upon the spokes can be transferred more easily and more effectively to the hub of the sheave.

In this connection, it can also be provided that each sheave spoke, on at least one end connecting it to the hub or to the sheave rim, has an essentially centred recess which reduces the surface of the joint with the hub and/or with the sheave rim. On the one hand, this measure again simplifies the mounting or connectivity of each spoke to the hub or to the rim, since the length of the interface is again reduced. But at the same time, it also reduces the absolute weight at this point, which is always an advantage, since less mass has to be accelerated and slowed down.

Finally it is preferred that the flat stock members of the spokes are made of steel with a suitable thickness which due to its undulation and the resulting good reachability is simple to weld to the hub and to the sheave rim, whereby the continuously even thickness of the steel also ensures a considerable quality advantage for the achievable positive material joint.

Further advantages and characteristics of the invention result from the following purely illustrative and in no way limiting description of a preferred embodiment of the invention, with reference to the enclosed drawings, where

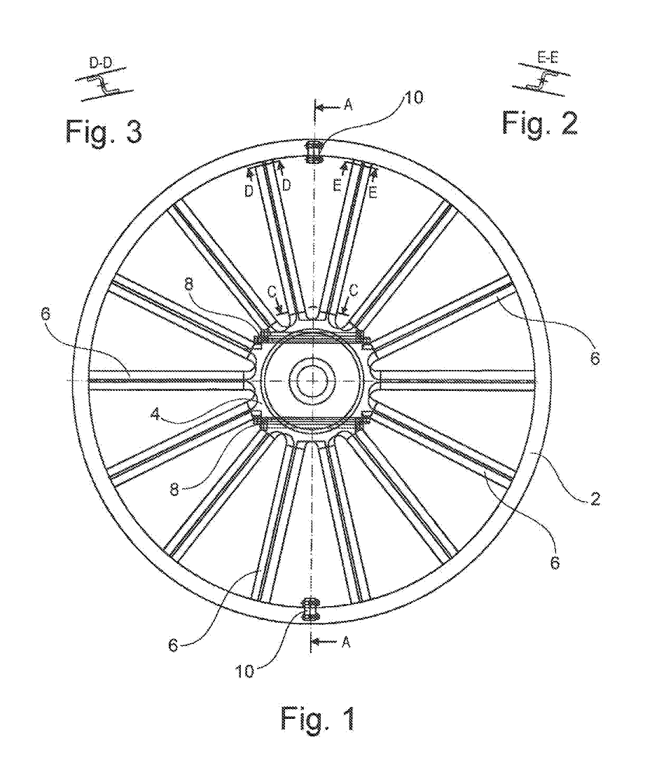

FIG. 1 shows a lateral view of the preferred embodiment of a sheave;

FIG. 2 shows a cross sectional view of a spoke according to line D-D in FIG. 1;

FIG. 3 shows a cross sectional view of a spoke according to line E-E in FIG. 1;

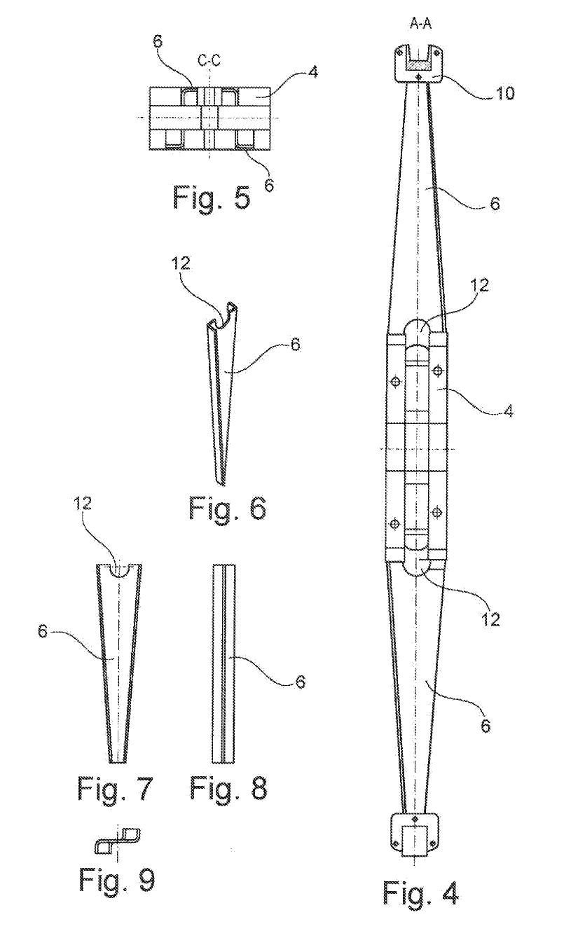

FIG. 4 shows a top view of the intersection of the semi discs of the sheave according to line A-A in FIG. 1;

FIG. 5 shows a cross sectional view of two spokes of the sheave according to line C-C in FIG. 1;

FIG. 6 shows a perspective view of a spoke of the sheave according to FIG. 1;

FIG. 7 shows a frontal view of a spoke of the sheave according to FIG. 1;

FIG. 8 shows a lateral view of a spoke of the sheave according to FIG. 1; and

FIG. 9 shows a top view of a spoke of the sheave according to FIG. 1.

FIG. 1 shows a lateral view of a sheave to be used as guide arrangement between a hoisting means and a rope carrier, with a sheave rim 2, a hub 4 and a plurality of sheave spokes 6 connecting the hub and the rim.

As can be seen readily from FIG. 1, the sheave consists of two semi-discs separated along line A-A which are detachably connected with threaded bolts 8 on hub 4 and with connecting flanges 10 at sheave rim 2.

FIGS. 2 and 3 show cross sections of spokes 6 of the sheave according to FIG. 1. As these figures show, each sheave spoke 6 consists of a single curved steel member with an S-shaped or Z-shaped cross section of equal thickness, which guarantees that the intersections can be easily reached, for example for welding operations, and which also guarantees a high area moment of inertia.

FIG. 4 shows a top view of the intersection of the semi-discs according to line A-A in FIG. 1. This shows especially the connecting flanges 10 and the interfaces of hub 4.

FIG. 5 shows a cross sectional view between two spokes 6 of the sheave according to line C-C in FIG. 1. This clearly shows how the interfaces of the sheave spokes 6 connected with hub 4 are formed by recess 12.

As FIGS. 2, 3 and 5 show in combination, the spokes in this embodiment are arranged across the entire width of hub 4 and sheave rim 2. The fact that hub 4 and sheave rim 2 have different widths is facilitated by the trapezoid design of spoke 6 across the width.

Finally, FIGS. 6, 7 and 8 show an exposed perspective view, a top view and a lateral view, respectively, of a sheave spoke 6 of the sheave according to FIG. 1.

1. A sheave to be used as guide arrangement between a hoisting means and a rope carrier, the sheave comprising:
a sheave rim;
a hub; and
sheave spokes connecting the hub and the rim;
wherein each sheave spoke is formed of a single flat stock member with a multi-curved trapezoidal cross section whose broad base is attached to the hub.

2. The sheave according to claim 1, wherein the cross section of the sheave spokes has an S-shaped undulation.

3. The sheave according to claim 1, wherein the cross section of the sheave spokes has a Z-shaped undulation.

4. The sheave according to claim 1, wherein the cross section of the sheave spokes has a W-shaped undulation.

5. The sheave according to claim 1, wherein each sheave spoke on at least one end connecting it to the hub or the sheave rim has an essentially centered recess which reduces the surface of the joint with the hub and/or the sheave rim.

6. The sheave according to claim 1, wherein the flat stock member consists of a steel plate of suitable thickness.
